(19) United States
(12) Patent Application Publication
(10) Pub. No.: US 2009/0161280 A1
(43) Pub. Date: Jun. 25, 2009

(54) THERMALLY PROTECTED METAL OXIDE VARISTOR HAVING PIN-TYPE DISENGAGING MECHANISM

(76) Inventor: Ching-Lung Tseng, Miaoli (TW)

Correspondence Address: RABIN & Berdo, PC, 1101 14TH STREET, NW, SUITE 500, WASHINGTON, DC, 20005, US

(21) Appl. No.: 12/099,236

(22) Filed: Apr. 8, 2008

(30) Foreign Application Priority Data
Dec. 21, 2007 (CN) 200720306105.5

(51) Int. Cl. H02H 5/04

(52) U.S. Cl. 361/103

(57) ABSTRACT

A thermally protected metal oxide varistor having a pin-type disengaging mechanism includes a varistor body having two metal electrodes coated thereon, an insulating layer enclosing the varistor, a first lead, a second lead, a third lead, a solder, and an elastic member. The first lead and the third lead are coupled to the varistor body. The solder is disposed at an electrical connection point of the varistor body. The elastic member is fixed at an outside of the insulating layer. The second lead includes a connection pin. The connection pin extends through the elastic member and is fixed by the solder to the electrical connection point. When an over-voltage occurs, temperature of the varistor body is raised to melt the solder. A restoring force provided by the elastic member disconnects the second lead from the electrical connection point of the varistor body.

### BACKGROUND OF THE INVENTION

1. Field of the Invention

The present invention relates generally to a surge protective device (SPD), and in particular to a thermally protected metal oxide varistor (TMOV) having a pin-type disengaging mechanism.

2. The Prior Arts

Zinc oxide (ZnO) based varistor is a common metal oxide varistor (MOV). In the MOV, nonlinear current-voltage characteristics depend on dopants doped in ZnO ceramic grains. A typical current-to-voltage curve of a metal oxide varistor can be divided into three regions: a leakage current region (pre-breakdown region), a non-ohmic region (breakdown region), and a large current region. When coupled with a load in parallel, and in normal operation in the leakage current region, the MOV is featured with a very large resistance, e.g., about 10¹² to 10¹³ Ω/cm, and a very small current, e.g., less than 1 mA. However, when suffering from a sudden voltage surge due to a lightening strike or a power failure, the voltage increases suddenly. When the voltage exceeds a breakdown voltage of the varistor employed therein, a ratio between the current (I) and the voltage (V) becomes a non-linear parameter (or non-ohmic parameter), which may reach a scale of tens or up to one hundred. In this situation, a resistance of the varistor will drop to only several ohms. In such a way, the MOV conduct a lot of current to eliminate the extra voltage, thereby providing protection to those electronic products or expensive components.

Although ZnO-based MOV can provide excellent protection against transient surge, they can not provide protection against over heating. Transient over voltage causes heat even fire, in which shutting off the circuit or disengage from the power line is one of the standard options. Therefore, besides circuit breakers, thermal fuses are also often used in electronic devices, and correspondingly the TMOV and SPD products are proposed. U.S. Pat. No. 6,636,403 discloses a typical TMOV which is a MOV having an integral thermally activated fuse for protection. Moreover, Chinese Patent Application No. 200610058396.0 and U.S. patent application Ser. No. 11/426,938 proposed further modifications of the TMOV.

However, what is taught by Chinese Patent Application No. 200610058396.0 and the conventional SPD include a disengage point, where a disengaging unit disengages from a main body. The disengage point is configured outside of an insulating layer of the SPD. As such, the conventional SPD has an external type of a disengaging mechanism, which is likely to be affected by ambient temperature. Thus, it is less reliable.

### SUMMARY OF THE INVENTION

A primary objective of the present invention is to provide a thermally protected metal oxide varistor, which prevents thermal runaway due to over-voltage conditions. A load is connected with the metal oxide varistor in parallel and a lead is connected with the metal oxide varistor in series. When operated in normal condition, the metal oxide varistor, the load and the lead are in a close circuit. When temperature raised by over voltage reaches a threshold temperature, the lead is disconnected from the metal oxide varistor. The metal oxide varistor, the load and the lead are in an open circuit. Thus, the metal oxide varistor and the load are protected against the high temperature.

The solution of the present invention is to equip a metal oxide varistor with a disengaging mechanism. A thermally protected metal oxide varistor having a pin-type disengaging mechanism according to the present invention includes a varistor body (i.e., a metal oxide varistor), metal coating layers (i.e., silver electrodes), an insulating layer enclosing the varistor body, a first lead, a second lead, a third lead, a solder, and an elastic member. The first lead and the third lead are coupled to the varistor body. The solder is disposed at an electrical connection point of the varistor body. The elastic member is fixed at an outside of the insulating layer. The second lead includes a connection pin. The connection pin extends through the elastic member and is fixed by the solder to the electrical connection point of the varistor body. When the connection pin is soldered to the electrical connection point, the varistor body is electrically connected with the second lead. The varistor body and the second lead are in a close circuit. When an over-voltage occurs, a high temperature is generated at the varistor body. The solder at the electrical connection point of the varistor body melts. Therefore, the elastic member, which is previously deformed, provides an elastic restoring force to flick the connection pin away from the electrical connection point of the varistor body, and pull the connection pin out of the insulating layer. The varistor body and the second lead are in an open circuit. Thus, the varistor body and a load, which is parallel-connected with the varistor body, are protected from the high temperature.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded view showing a thermally protected metal oxide varistor having a pin-type disengaging mechanism according to the present invention;

FIG. 2A is a side cross-sectional view of the thermally protected metal oxide varistor having the pin-type disengaging mechanism according to the present invention, when operated in a normal condition;

FIG. 2B is a side cross-sectional view of the thermally protected metal oxide varistor having the pin-type disengaging mechanism according to the present invention, when operated in an over-voltage condition; and

FIG. 3 is a schematic view showing a load and the thermally protected metal oxide varistor having the pin-type disengaging mechanism are connected in parallel.

### DETAILED DESCRIPTION OF THE PREFERRED EMBODIMENT

The accompanying drawings are included to provide a further understanding of the invention, and are incorporated in and constitute a part of this specification. The drawings illustrate an embodiment of the present invention and, together with the description, serve to explain the principles of the invention.

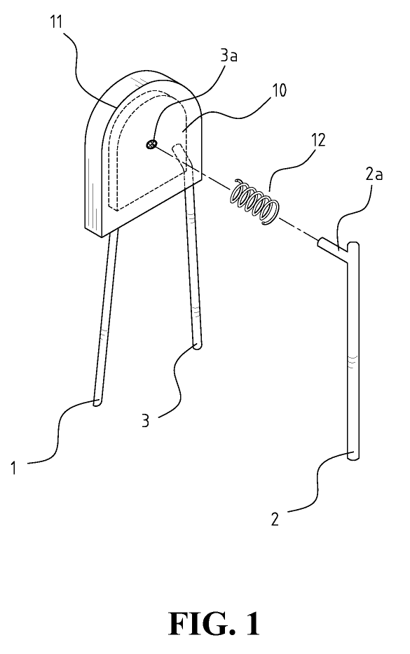

Referring to FIG. 1, a thermally protected metal oxide varistor having a pin-type disengaging mechanism includes a varistor body 10, an insulating layer 11, a first lead 1, a second lead 2, a third lead 3, a solder 3a, and an elastic member 12. The varistor body 10, which is a metal oxide varistor, includes a first surface A on one side thereof and a second surface B on the other side thereof. A first electrode 10a and a second electrode 10b are coated on the first surface A and the second surface B, respectively. The first electrode 10a and the second electrode 10b may be made of silver. The first lead 1 and the third lead 3 are soldered to the first electrode 10a and the second electrode 10b, respectively. The solder 3a is enclosed in the insulating layer 11 and disposed at an electrical connection point of the varistor body 10. The electrical connection point is positioned at the second metal electrode 10b or an end of the third lead 3. The solder 3a may be a tin alloy. The elastic member 12 is fixed at an outside of the insulating layer 11. The second lead 2 includes a connection pin 2a. The elastic member 12 can be an elastic sheet, a spring, or other elastic components. The pin-type thermally protected disengaging mechanism according to the present invention is subject to application for the SPDs or TMOVs.

As shown in FIG. 1, the first lead 1, the second lead 2 and the third lead 3 are all metal wires. The first lead 1 and the third lead 3 are partially enclosed in the insulating layer 11 and are respectively soldered to the first electrode 10a and the second electrode 10b of the varistor body 10. The solder 3a is adapted to be in a solid state under a room temperature, and in a melt state when heated to a predetermined temperature. The elastic member 12 is fastened to the outside of the insulating layer 11, and is adapted to provide an elastic restoring force. The connection pin 2a of the second lead 2 extends through the elastic member 12 and is fixed at the electrical connection point of the varistor body 10 by the solder 3a. It should be specifically noted that the alloy ingredient of the solder 3a should be determined in accordance with the aforementioned predetermined temperature, which is determined by a desired threshold of the over-voltage.

Briefly, in normal operation, the second lead 2 is connected with the second electrode 10b or the third lead 3 by the solder 3a, and therefore the varistor body 10 and the second lead 2 are in a close circuit. When an abnormal issue, e.g., over-voltage, occurs, the second lead 2 is disconnected from the second electrode 10b or the third lead 3, and therefore the varistor body 10 and the second lead 2 are in an open circuit. In order to obtain the foregoing, the thermal protected metal oxide varistor having a pin-type disengaging mechanism according to the present invention employs the solder 3a to connect the connection pin 2a of the second lead 2 with the second electrode 10b or the third lead 3. In such a way, when an over-voltage causes a high temperature, the solder 3a melts. The elastic member 12 disposed at the outside of the insulating layer 11 produces an elastic restoring force to flick the connection pin 2a away from the electrical connection point of the varistor body 10, thereby pulling the connection pin 2a away from the insulating layer 11. Thus, the second electrode 10b or the third lead 3 is disconnected from the second lead 2.

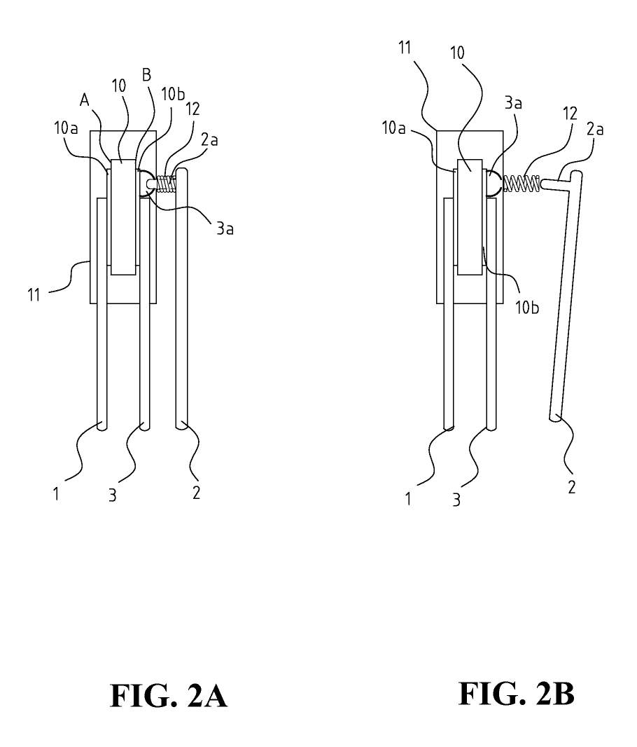

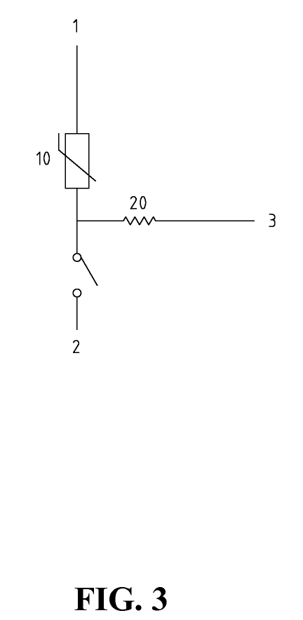

Referring to FIG. 2A, when the connection pin 2a of the second lead 2 is soldered by the solder 3a to the electrical connection point of the varistor body 10, the second lead is electrically connected with the varistor body 10. The varistor body 10 and the second lead 2 are in a close circuit. Referring to FIG. 3, the varistor body 10 is connected with a load 20 in parallel. A voltage provided is conducted through the lead 2, the varistor 10, and the lead 1 under normal circumstance as the varistor body 10 operates in the leakage current region and presents a very large resistance to the voltage. Most of the current go through the load 20. When the over-voltage occurs, the varistor body 10 enters the non-ohmic region. The resistance of the varistor body 10 drops and most of the current goes through the varistor body 10. Thus, the load 20 is protected from the over-voltage.

Referring to FIGS. 2B and 3, when there is an over-voltage occurs between two electrodes 10a and 10b, a high temperature is generated at the varistor body 10 which melts solder 3a. The elastic member 12, which is previously deformed, is then released to restore to its original state and provides a restoring force. The restoring force flicks the connection pin 2a away from electrical connection point of the varistor body 10, and pulls the connection pin 2a away from the insulating layer 11. In such a way, the second lead 2 is disconnected from the varistor body 10 and the load 20. Thus, the varistor body 10 and the load 20 are protected from the over voltage.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A thermally protected metal oxide varistor having a pin-type disengaging mechanism, comprising:
a varistor body having a first metal electrode coated on one side thereof and a second metal electrode coated on the other side thereof;
an insulating layer enclosing the varistor body;
a first lead configured as a metal wire, partially enclosed in the insulating layer, and soldered to the first metal electrode;
a solder disposed at an electrical connection point of the varistor body, wherein the solder is adapted to change from a solid state to a melt state when being heated from a normal temperature to a predetermined temperature;
an elastic member fixed at an outside of the insulating layer and adapted for providing an elastic restoring force; and
a second lead configured as a metal wire, comprising a connection pin, the connection pin extending through the elastic member and being fixed by the solder to the electrical connection point of the varistor body,
wherein the electrical connection point of the varistor body is disposed at the second metal electrode.

2. The thermally protected metal oxide varistor according to claim 1, wherein the varistor body is one of a metal oxide varistor, a metal oxide varistor coated with silver, and a ceramic varistor.

3. The thermally protected metal oxide varistor according to claim 1, wherein the elastic member is one of an elastic sheet and a spring.

4. The thermally protected metal oxide varistor according to claim 1, further comprising:
a third lead configured as a metal wire, partially enclosed in the insulating layer, and soldered to the second metal electrode;
wherein the electrical connection point of the varistor body is disposed at one of the third lead and the second metal electrode.

5. The thermally protected metal oxide varistor according to claim 1, wherein the solder is a tin alloy.

6. The thermally protected metal oxide varistor according to claim 1, wherein at least one of the first metal electrode and the second metal electrode is a silver electrode.

7. The thermally protected metal oxide varistor according to claim 1, wherein the metal wires are configured with metal sheets.

8. The thermally protected metal oxide varistor according to claim 1, wherein the second lead and the connection pin are individually formed or integrally formed.
